(19) United States
(12) Patent Application Publication
(10) Pub. No.: US 2003/0174821 A1
(43) Pub. Date: Sep. 18, 2003

(54) Method and apparatus for calling card callbacks

(75) Inventors: Cary Lee Bates, Rochester, MN (US); Mahdad Majd, Rochester, MN (US); John Matthew Santosuosso, Rochester, MN (US)

Correspondence Address: IBM Corporation, Intellectual Property Law Dept. 917, 3605 Hwy. 52 North, Rochester, MN, 55901, US

(73) Assignee: INTERNATIONAL BUSINESS MACHINES CORPORATION, ARMONK, NY

(21) Appl. No.: 10/097,891

(22) Filed: Mar. 14, 2002

(51) Int. Cl. H04M 15/00; H04M 3/42

(52) U.S. Cl. 379/114.15; 379/114.05; 379/210.01

(57) ABSTRACT

Embodiments of the invention provide a method, article of manufacture, and apparatus for telephone calling card caller identification. In one embodiment, a processing system is adapted to supply pre-defined call back information from a calling card user to a recipient/caller. In another embodiment, the recipient/caller uses the pre-defined call back information to call the calling card user at one or more telephone numbers specified by the call back information. In another embodiment, the processing system uses the pre-defined call back information to automatically connect the recipient/caller to the calling card user at one or more specified telephone numbers. In another embodiment, the pre-defined call back information includes at least one timed temporary calling card number for the recipient/caller to use to contact the calling card user where the temporary calling card number may have an expiration time and/or date. In another embodiment, at least some of the call back information is transmitted to the calling card user to identify the recipient/caller.

### BACKGROUND OF THE INVENTION

1. Field of the Invention

Embodiments of the invention generally relate to telephony. More particularly, the invention relates to telephony using calling cards.

1. Description of the Related Art

Generally, telephone calling cards are designed to allow the calling card user to make telephone calls from virtually any telephone. Conventional telephone calling cards can be pre-paid or on a billed calling plan that facilitates telephone communications from virtually anywhere in the world from one communication system to another, such as from one telephone to another telephone. One example of a pre-paid calling card plan is a “pre-paid” calling card where the amount of minutes used is deducted from the total amount of available paid for minutes. Additionally, as telephone calling cards have become popular worldwide, many countries use the card for convenience calling within the country and to other countries around the world.

While calling cards are convenient, individuals may not always carry or have access to calling cards if immediately needed. Consider, for example, an employee who receives an urgent call from a friend to call them immediately, and who is not allowed to use the employer's phone without a calling card access number. In this case, the employee may have to wait for a break period to use a pay phone, or perhaps a cellular phone.

Generally, caller identification systems are used to transmit the identity of the phone the caller is calling from to the receiver. As the caller identification systems throughout the United States, and the world, often are incompatible and do not communicate the proper identification of the originating telephone the number displayed to the recipient of a call may be missing or incorrect. For example, a telephone system in California may not effectively work with the caller identification of a telephone system in Texas and therefore mask or transmit incorrect caller identification. Often, the recipient of the call may use the caller identification system to selectively screen the call to determine who is calling, and may reject the call if the number displayed is missing or unknown, often frustrating the caller. Thus, as telephone call identification is being used more frequently to help the receiver of a call screen incoming calls, inoperable or otherwise incorrect caller identification due to system incompatibilities can cause lost time and aggravation for the caller.

Caller identification systems may not be compatible with calling card processing systems. Accordingly, when a calling card is used to place a call, the identity of the calling number may be hidden, or incorrect, causing the receiver to reject the call. For example, a calling card user may make a calling card call from a telephone within a business, or perhaps from a pay phone, that may have unrecognizable caller identification, no caller identification functionality and/or data, making it difficult to determine the identity of the calling card caller. Accordingly, the receiver of the call may reject calls otherwise accepted had the proper caller identification been given.

Therefore, there is a need for a telephone calling card that is easy to use and facilitates telephone call identification in an efficient and cost effective manner.

### SUMMARY OF THE INVENTION

The invention generally provides a method, article of manufacture, and apparatus for sending and processing call back data when using a calling card. In one embodiment, the invention provides a method of processing a telephone call at a communication processing system, wherein the telephone call is made from a telecommunications device by a user using a telephone calling card. The telecommunications device can be any device (including a computer, a mobile telephone, a land-based telephone, a PDA, etc.) capable of transmitting information to the communication processing system. Once a connection is established with the telecommunications device, the communication processing system begins receiving data and/or commands from the telecommunications device. The data and/or commands contain or otherwise configure call back information to be stored in a repository. At least a portion of the call back information can then be retrieved and transmitted to another telecommunications device when the user places a call using the telephone calling card.

In another embodiment, the invention provides a method of processing a telephone call at a communication processing system, wherein the telephone call is made from a first telecommunications device by a caller using a calling card to a second telecommunications device. The method includes processing a telephone calling card identification number received from the first telecommunications device, then retrieving call back information associated with the telephone calling card identification number; and subsequently transmitting at least part of the call back information to the second telecommunications device.

In another embodiment, the invention provides a telecommunications system for processing telephone calls made from telecommunications devices. The telecommunications system comprises a data repository containing call back information associated with a calling card. The telecommunications system further comprises a processing system configured to at least receive a telephone call made from a first telecommunications device to a second telecommunications device, wherein the telephone call is made from the first telecommunications device by a caller using the calling card. Further, the processing system retrieves the call back information associated with the calling card, and then transmits at least part of the call back information to the second telecommunications device.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts one embodiment of a communications system in accordance with aspects of the invention.

FIG. 2 depicts one embodiment of a memory core for storing programming data in accordance with aspects of the invention.

FIG. 3 illustrates one embodiment of a caller identification data structures related to the calling card user identity data in accordance with aspects of the invention.

FIG. 4 illustrates one embodiment of a call back identification data structures related to the caller identification data in accordance with aspects of the invention.

FIG. 5 is a flow diagram of one embodiment of a method for establishing calling card user and call back information in accordance with aspects of the invention.

FIG. 6 is a flow diagram of one embodiment of a method for determining a call back identification to be transmitted in accordance with aspects of the invention.

FIG. 7 is a flow diagram of one embodiment of a method for receiving a return call with caller identification in accordance with aspects of the invention.

### DETAILED DESCRIPTION OF THE PREFERRED EMBODIMENTS

Embodiments provide a method, article of manufacture, and apparatus for customizing telephone calling card features, options, and configurations to facilitate caller identification and call back information. As used herein “configuration” includes any configuration data or values regardless of format, or length. A value may be a single character (e.g., letter, numeral, symbol, etc.) or may be a string of characters (e.g., a phrase). A calling card user is defined herein to mean at least one person or entity that uses a calling card to access a recipient/caller. A recipient/caller is defined herein as at least one person or entity receiving (i.e., a receiver) information from the calling card user, and then acting on the information by, for example, using the calling card identification and parameters provided by the calling card user (e.g., calling the calling card user).

While the invention has and hereinafter will be described in the context of fully functioning computers and computer systems (such as, for example, the networked telephonic communications system 100 described below), those skilled in the art will appreciate that the various embodiments of the invention are capable of being distributed as a program product. The program(s) of the program product defines functions of the embodiments (including the methods described below) and can be contained on a variety of signal-bearing media and that the invention applies equally regardless of the particular type of signal bearing media used to actually carry out the distribution. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the invention, represent embodiments of the invention.

In general, the routines executed to implement the embodiments of the invention, may be implemented as part of an operating system or a specific application, component, program, module, object, or sequence of instructions. The inventive computer code typically is comprised of a multitude of instructions that will be translated by the native computer into a machine-readable format and hence executable instructions. In addition, the programs may be comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

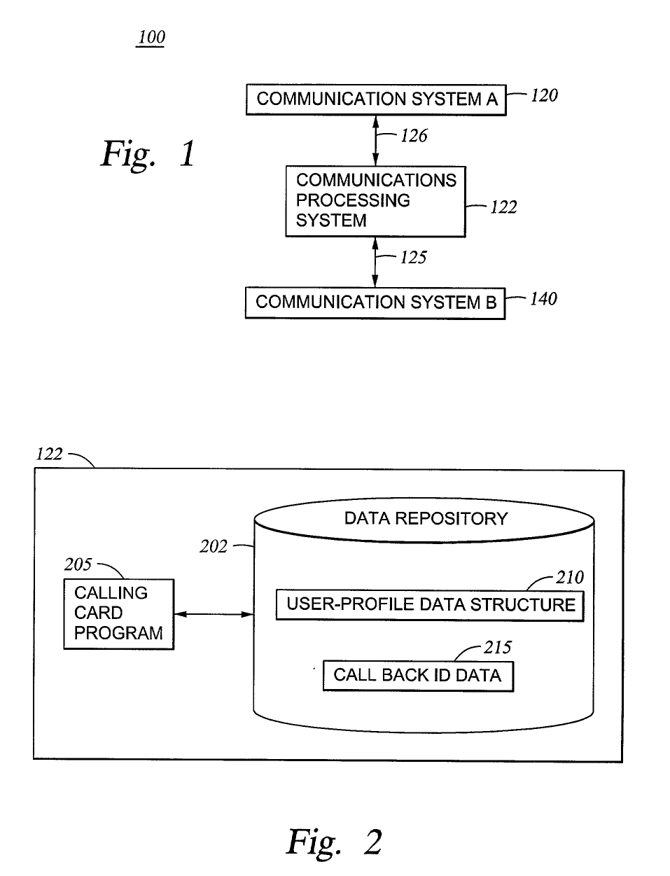

FIG. 1 depicts one embodiment of a networked telephonic communications system 100. In general, the networked telephonic communications system 100 includes a telephone call processing system 122 adapted to connect at least one communication connection system A 120 to another communication system B 140. The communication systems 120,140 represent communication devices such as telephones, mobile phones, radios, and any other telephony devices adapted to provide two-way communication. The communication systems 120-140, are coupled to the telephone call processing system 122 via a transmission connection 125 such as telephone wires, cables, twisted pair, and others, including wireless connections, adapted to provide a two-way communication connection.

In general, the telephone call processing system 122 is any system capable of performing the functions disclosed herein. As such, the invention contemplates any suitable combination of hardware and software readily identified by persons skilled in the art. FIG. 2 depicts one embodiment of the telephone call processing system 122. Illustratively, the telephone call processing system 122 is configured with a data repository 202 which contains various data structures used to facilitate the operation and configuration of embodiments of the invention. The data repository 202 is accessed by a calling card program 205. In one embodiment, the calling card program 205 receives and processes external commands from a calling card user to facilitate the use of the calling card operation and interface with external caller identification systems. The calling card program 205 includes functions that are accessible to the calling card user using commands inputted by characters and phrases entered such as alpha-numeric characters, phrases, voice commands, and the like. Illustrative functions of the calling card program 205 include calling card user name identification, number identification, call back instructions, forwarding, routing, messaging, and others. These and other functions are facilitated with the information stored in the data repository 202.

In one embodiment, the data repository 202 contains a user-profile data structure 210 and a call back identification data structure 215 in which calling card users are associated with call back identification data. The calling card program 205 is adapted to store and/or retrieve the calling card users profile data and/or the call back identification data from the data repository 202.

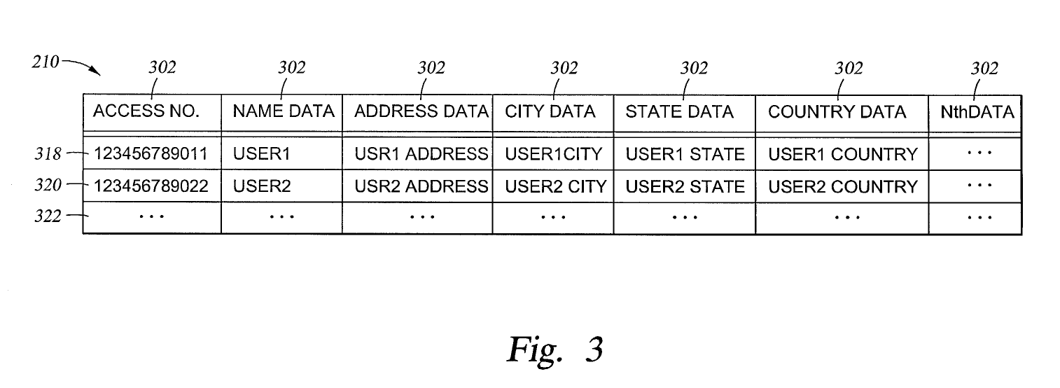

FIG. 3 illustrates one embodiment of the user-profile data structure 210. User-specific data entered for a calling card user profile is stored in the user-profile data structure 210. Each column 302-314 defines one of a plurality of elements of calling card user data related to a particular calling card access number (i.e., calling card). Illustratively, the user-profile data structure 210 includes a user access number column 302 specific to a particular calling card user, a user name column 304, a user address column 306, a user city column 308, a user state column 310, and a user country column 312, defining the calling card users name, address, state, and a country, respectively. The user-profile data structure 210 also contains an NthData column 314 defining a plurality of other types of calling card user data such as, for example, credit card numbers, date of birth, and the like. Each row 318-322 of the user-profile data structure 210 defines elements of a single calling card user record. Illustratively, the user-profile data structure 210 includes a row 318 for a first calling card user, a second row 320 for a second calling card user, and an nth row 322 illustrating that a plurality of calling card users may be part of the user-profile data structure 210.

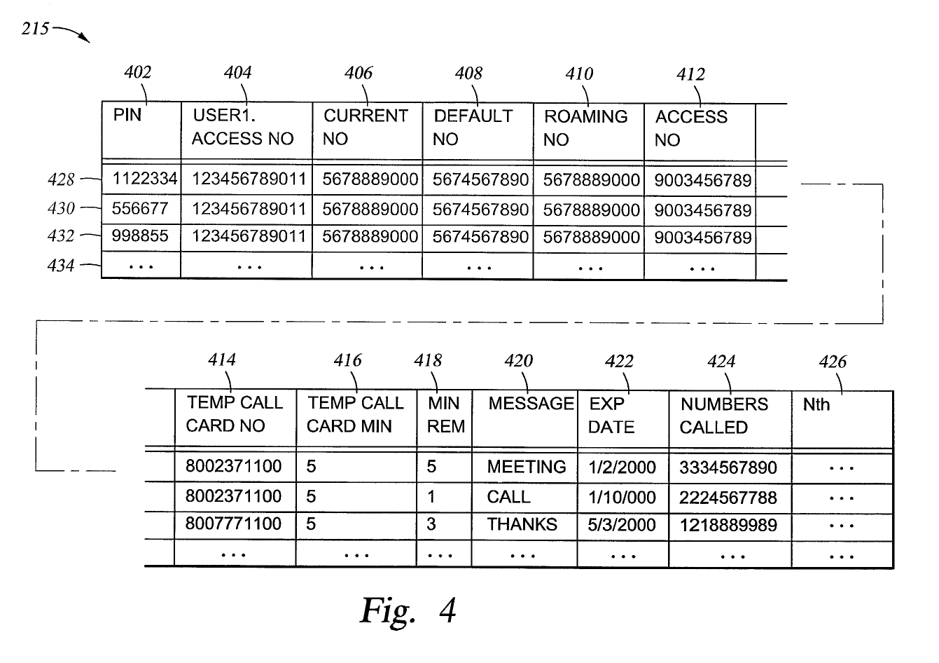

FIG. 4 illustrates one embodiment of the call back identification data structure 215 and includes call back identification data and parameters associated with one or more calling card users. FIGS. 1-3 are referenced within the following discussion of FIG. 4 as is necessary.

The call back identification data structure 215 includes data columns 402-426 having data elements and functions specific to one or more calling card users. Each row 428-434 of the call back identification data structure 215 defines elements and parameters associated with a single call back identification data record associated with one or more calling card users. It is contemplated, as illustrated by the Nth row 434, that any number of individual call back identification data records may be stored within the call back identification data structure 215. The call back identification data structure 215 includes a temporary calling card identification number column 402 for storing temporary calling card access numbers, and a user access number column 404 to associate at least one temporary calling card access number to at least one calling card user from the user access number column 302 (see FIG. 3).

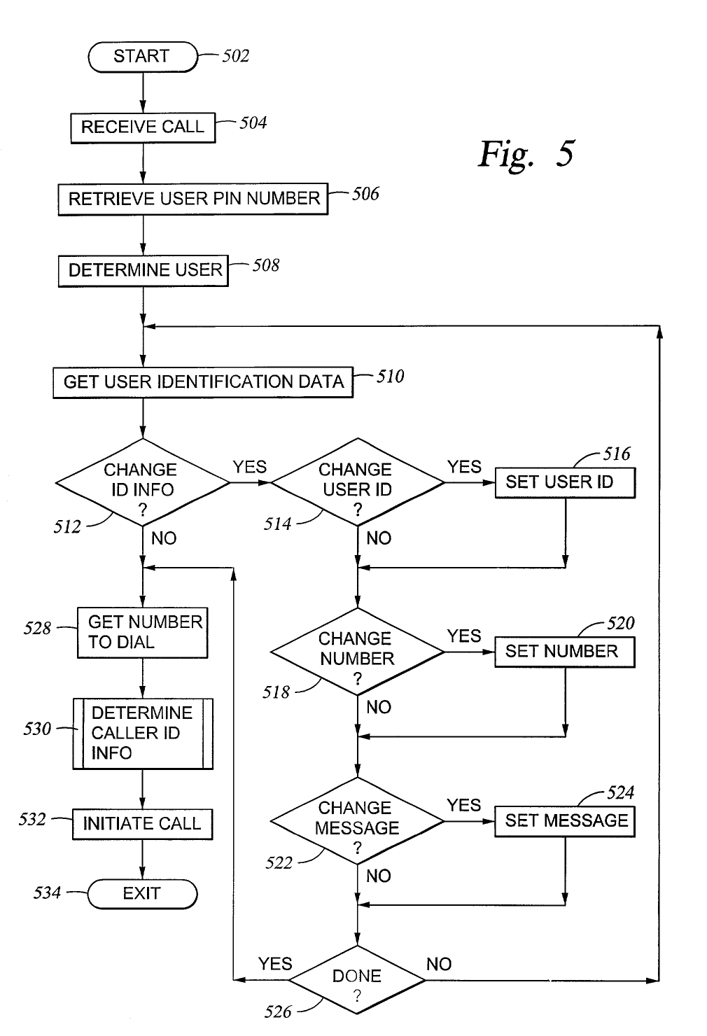

The call back identification data structure 215 may also include a current number column 406 to store the number the calling card user is calling from, and a default number column 408 if no current number is stored in the current number column 406, or entered by the calling card user as described below with respect to FIG. 5. For example, if the calling card user is calling from a phone that does not provide a number to the calling card program 205, and the calling card user does not enter a number, a default number may be used from the default number column 408. The call back identification data structure 215 may also include a roaming number column 410 to store at least one roaming number used to connect (e.g., forward) to the calling card user from virtually any phone. For example, the roaming number may be an intermediate phone number setup to which incoming calls (e.g., calls to the current phone number, default phone number, and the like) are redirected. Alternatively, the roaming number may be flagged to track any other number such as the current number. For example, a “*current” flag may be set in lieu of a specific roaming number so that as the current number changes, the roaming number changes correspondingly to the current number.

The call back identification data structure 215 also includes a recipient/caller access number column 412 to store recipient/caller access numbers. The caller access numbers may be used to call the calling card user at various phone numbers such as the current phone number, default phone number, cellular phone number, and the like. For example, the recipient/caller may call an access number that forwards the recipient/caller to a number designated by the calling card user, such as the default phone number. Recipient/caller access numbers may be configured with a toll charge, where the recipient/caller pays for the call, or alternatively as a toll-free number, where the recipient/caller does not pay for the call. In one aspect, the access numbers is a 900 number wherein a recipient/caller pays a fee to call the calling card user associated with the recipient/caller direct access number.

In another embodiment, the call back identification data structure 215 includes a temporary calling card phone number column 414 adapted to store at least one temporary calling card and an associated temporary calling card minutes column 416 to store a defined number of temporary calling card minutes for the respective temporary calling card phone number. The temporary calling card is one or more calling cards that have a predetermined expiration date and/or time limit that are issued by the calling card user to one or more recipient/callers. Each temporary calling card may include a temporary calling card number and associated temporary calling card identification number. In one embodiment, each temporary calling card is given a time limit (e.g., minutes) and/or an expiration date. To track the amount of unused minutes for each temporary calling card number located in column 414, the identification data structure 215 includes a minutes remaining column 418. A temporary calling card may be configured with any amount of time, and is contemplated to be used by one or more recipient/callers. For example, a temporary calling card and associated temporary calling card identification number may be given to only one recipient/caller, or may be given to plurality of recipient/callers.

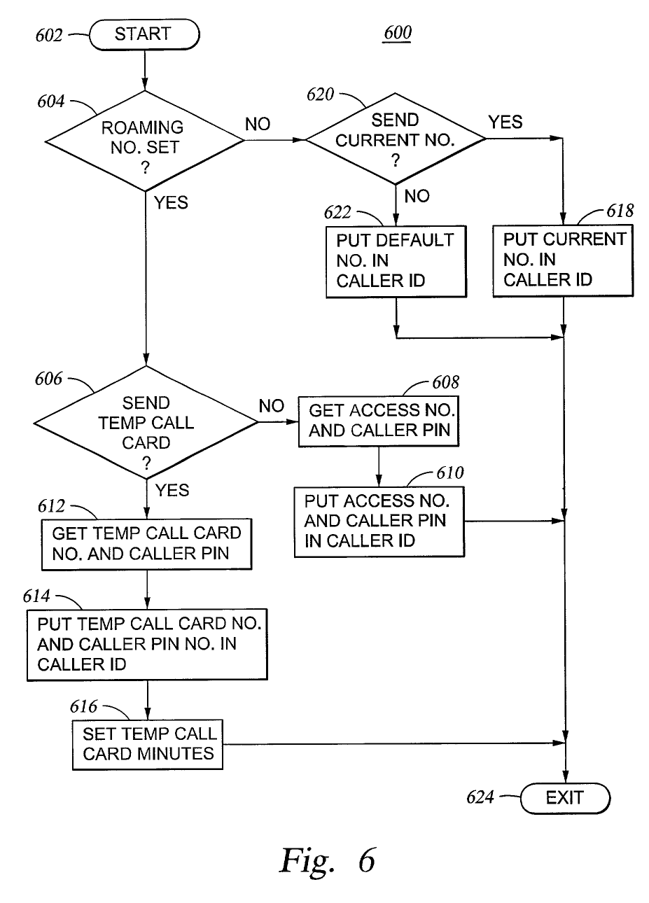

In another embodiment, the call back identification data structure 215 may include a message column 420 to store messages that may be sent along with other call back caller identification information. In one embodiment, messages may be used to inform the recipient/caller about the whereabouts of the calling card user being called. For example, if the message said “In meeting”, the recipient/caller is given instruction that the calling card user is in a meeting. The call back identification data structure 215 may also include an expiration date column 422 specifying an expiration date of the temporary calling card. The expiration date may be used to keep the temporary calling cards from operation past a certain time or date. For example, the calling card user may not wish the temporary calling card to last more than thirty days, after which the temporary calling card becomes inoperative. In one embodiment, the call back identification data structure 215 includes a last number called column 424 as will be described below with respect to FIGS. 5-6. Column 426 illustrates that any number of additional configurations is contemplated.

FIG. 5 is a flow diagram of a method 500 for establishing calling card caller identification in accordance with aspects of the invention. FIGS. 1-4 are referenced within the following discussion of FIG. 5 as is necessary. Specifically, the method 500 starts at step 502 when a call back process is initiated by the telephone calling card program 205. The telephone calling card program 205 may be activated when a calling card user uses the calling card to access the networked telephonic communications system 100 to send call back information to one or more recipient/callers. By way of illustration, it can be assumed that the calling card user initiates a network connection with the system 100 from the communication device A. The method 500 proceeds to step 504 and receives the call. At step 506, the method 500 gets the user access number (e.g., user PIN number) entered by the current calling card user. Once the calling card user identification has been retrieved, the method 500 proceeds to step 508 to identify the calling card user. In one embodiment, to determine the identity of the calling card user, the method 500 correlates the user access number as entered to the calling card user information within the user-profile data structure 210. It is contemplated that if the user access number is incorrect, or the calling card user cannot be identified, that an error message may be sent to the calling card user to reenter the user access number. At step 510, the method 500 retrieves the calling card user call back identification from the call back identification data structure 215 and the user-profile data structure 210. In one embodiment, the method 500 determines whether the information within the user-profile data structure 210 and call back identification data structure 215 is to be changed. This determination may be made in response to input (e.g., in the form of keypad entries on a telephone or voice commands) from the current calling card user. If the information within the user-profile data structure 210 and/or the call back identification data structure 215 is not to be changed, then the method 500 proceeds to step 528 described below. If the information within the user-profile data structure 210 and the call back identification data structure 215 is to be changed, then the method 500 proceeds to step 514. At step 514, the method 500 determines if the calling card user identification such as the user name, address, and the like, from columns 304-314 is to be changed. If the method 500 determines the calling card user identification is not to be changed, then the method 500 proceeds to step 518 described below. If the method 500 determines the calling card user identification is to be changed, then the method 500 proceeds to step 516. At step 516, the method 500 changes the calling card user identification. In one embodiment, the calling card user identification may be changed by prompting the calling card user to enter new user identification. Alternatively, the calling card user identification may be changed by a selection of various alternative calling card user identifications from a database, such as the user-profile data structure 210. For example, the calling card user name “John” and an alternative calling card user name such as “Dr. John Smith” may be stored in the user-profile data structure 210 to allow the calling card user to select various calling card user name identifications to be transmitted to the recipient/caller.

At step 518, the method 500 determines if the call back number is to be changed. If the call back number is not to be changed, then the method 500 proceeds to step 522 described below. If the call back number is to be changed, then the method 500 proceeds to step 520 where the desired number is set. In one embodiment, at step 520, the call back number is changed to reflect at least one number from the call back identification data structure 215. For example, the number to be sent may be the call back access number from the recipient/caller access number column 412. The calling card user may change the recipient/caller access number to any of the numbers within the call back identification data structure 215 such as the current number or default number depending on the calling card users preference. It is contemplated that more than one number from the call back identification data structure 215 may be sent to give the recipient/caller a variety of call back calling options.

At step 522, the method 500 determines whether the message to be sent should be changed. If the message is not to be changed, then the method 500 proceeds to step 526 described below. If the message is to be changed, then the method 500 proceeds to step 524 to change the message. In one embodiment, the message may be changed by prompting the calling card user to enter a new message. Alternatively, the message may be changed by a selection of various alternative messages from a database, such as the user-profile data structure 210. For example, the message “meeting” and an alternative name such as “call me” may be stored in the call back identification data structure 215 to allow the calling card user to select various messages as desired. At step 526, the method 500 determines whether more changes to the call back identification data are required. If there are more changes necessary, the method 500 returns to step 510 and repeats the process. If there are no more changes necessary, the method 500 may end or may proceed to step 528 if the calling card user desires to make a telephone call using the calling card.

At step 528, the method 500 retrieves the phone number to dial. At step 530, the method 500 determines the call back identification to transmit to the recipient/caller as discussed below with respect to FIG. 6. Once the call back identification has been established at step 530, the method 500 then proceeds to step 532 to initiate the call and transmit the call back identification to the recipient/caller and then exits at step 534.

FIG. 6 is a flow diagram of one embodiment of a method 600 representative of step 530 for determining at least one call back identification to be transmitted in accordance with aspects of the invention. FIGS. 1-5 are referenced within the following discussion of FIG. 6 as is necessary.

Specifically, the method 600 starts at step 602 when, at step 530, the call back information to be transmitted to a recipient/caller is to be determined. At step 604, the method 600 determines if the roaming number from the roaming number column 410 is available to be sent. If the roaming number is not available, then the method 600 proceeds to step 620. At step 620, the method 600 determines if the current number is available to be sent with the call back information at step 532. If the current number is unavailable, then the method 600 proceeds to step 622 as described below. If the current number is available from the current number column 406, then the method 600 proceeds to step 618, puts the current number into the call back information, then proceeds to step 624. If the current number is unavailable, at step 622, the method puts the default number in the call back information, then proceeds to step 624. Subsequently, the method 600 exits from step 624 back to step 532.

If the roaming number is available at step 604, the method 600 proceeds to step 606. At step 606, the method 600 determines if a temporary calling card number from the temporary calling card number column 414 is to be sent within the call back information. If a temporary calling card number is to be sent, then the method 600 proceeds to step 612. At step 612, the method 600 determines the temporary calling card number and a recipient/caller personal identification number associated with the temporary calling card number. It is contemplated that the temporary calling card number and recipient/caller personal identification number may be derived any number of ways. For example, in one embodiment the method 600 may create the temporary calling card numbers and recipient/caller personal identification numbers and then store them into the call back identification data structure 215. Alternatively, the temporary calling card numbers and recipient/caller personal identification numbers may be preloaded in the call back identification data structure 215 for subsequent retrieval. At step 614, the method 600 puts the temporary calling card number and recipient/caller personal identification number into the call back information. At step 616, the method 600 establishes the amount of time (e.g., minutes) that the temporary calling card is valid for and, in one embodiment, the expiration date and then exits at step 624 to step 532. In one embodiment, the temporary calling card may be set for a time limit and/or an expiration date. For example, the temporary calling card may be set for a limit of five minutes with a one-month expiration date. It is contemplated that the time and/or the expiration date may be derived a number of ways. For example, in one embodiment, the method 600 may create the time and/or the expiration date and store them into the call back identification data structure 215. Alternatively, the time and/or the expiration date may be pre-loaded in the call back identification data structure 215 for subsequent retrieval.

If a temporary calling card number is not to be sent at step 606, then the method 600 proceeds to step 608. At step 608, the method 500 determines the access number (e.g., 900 number) and, in one embodiment, a recipient/caller personal identification number associated with the access number. It is contemplated that access numbers and recipient/caller personal identification numbers may be derived in a number of ways. For example, in one embodiment, the method 600 may create one or more access numbers and recipient/caller personal identification numbers, and then store them in the call back identification data structure 215. Alternatively, the one or more access numbers and recipient/caller personal identification numbers may be preloaded in the call back identification data structure 215 for subsequent retrieval. Although the recipient/caller personal identification numbers may be adapted to work with one or more access numbers and/or temporary calling cards, it is contemplated that the recipient/caller personal identification numbers may be unique for one or more of the access numbers and and/or the temporary calling card numbers. In another embodiment, a recipient/caller access number pin may not be required, as one or more access numbers and and/or temporary calling card numbers are unique.

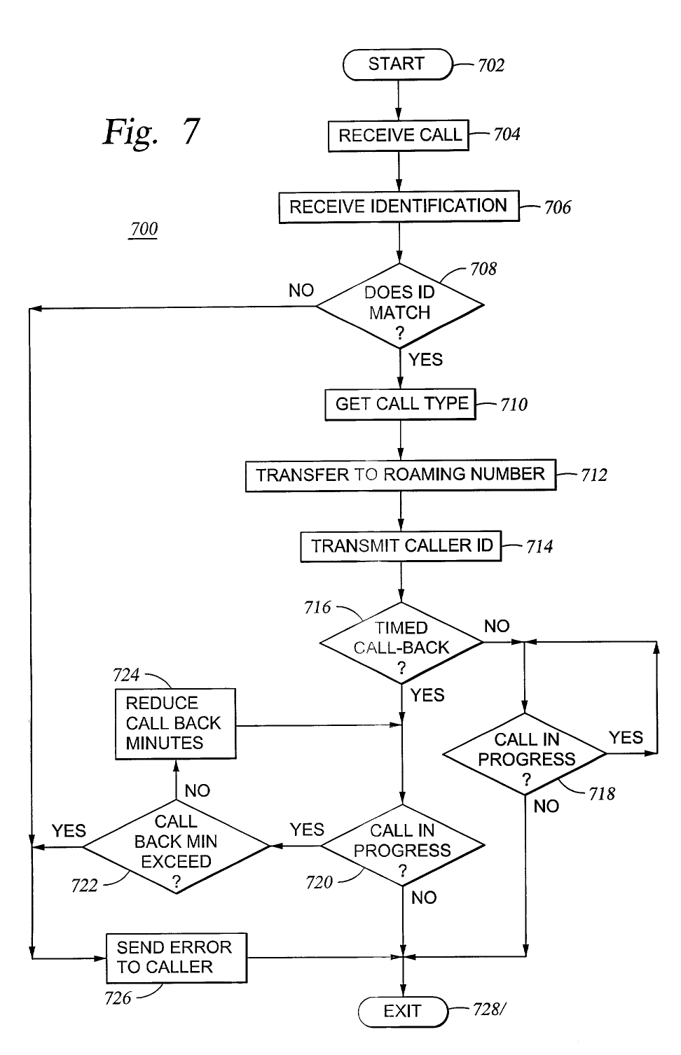

FIG. 7 is a flow diagram of one embodiment of a method 700 for receiving a return telephone call from a recipient/caller using the call back information provided by a calling card user in accordance with aspects of the invention. FIGS. 1-6 are referenced within the following discussion of FIG. 7 as is necessary.

Specifically, the method 700 starts at step 702, for example, when a call back process is initiated by the telephone calling card program 205 when a recipient/caller accesses the networked telephonic communications system 100 using information provided within a call back identification transmission to the recipient/caller. At step 704, the telephone call is received by the system 100 from the recipient/caller from, for example, communication system B. At step 706, the method 700 retrieves, from the caller identification data, the recipient/caller personal identification number entered by the recipient/caller. If no recipient/caller personal identification number is available, it is contemplated that the method 700 may prompt the recipient/caller to enter the recipient/caller personal identification number and/or number used to make the call. At step 708, the method 700 determines if the recipient/caller personal identification number correlates with a calling card user from the call back identification data structure 215 by comparing the recipient/caller personal identification number entered by the recipient/caller to the recipient/caller personal identification numbers within the call back identification data structure 215. If the recipient/caller personal identification number is determined to be invalid, then the method 700 proceeds to step 726 and send an error to the recipient/caller. After sending the error, the method 700 may exit at step 728 or, alternatively, may prompt the recipient/caller to re-enter the recipient/caller personal identification number. If the recipient/caller personal identification number correlates, the method 700 proceeds to step 710 to get the call type (e.g., timed call or non-timed call). In one embodiment, the method 700 gets the telephone call type by retrieving the phone number of the telecommunications device 120 the caller used to access the networked telephonic communications system 100. For example, if the recipient/caller accessed the networked telephonic communications system 100 using an access number from the caller access number column 412 corresponding to the entered recipient/caller personal identification number retrieved from step 706, the method 700 flags the call a non-timed call. However, if the recipient/caller accessed the networked telephonic communications system 100 using a temporary calling card number from the temporary calling card number column 414, corresponding to the recipient/caller personal identification number retrieved from step 706, the method 700 flags the call type as a timed call (e.g., temporary calling card). While it is contemplated that the access number and temporary calling card number may be used by a plurality of recipient/callers, each having a unique recipient/caller personal identification number, it is contemplated that alternatively the recipient/caller personal identification number may stipulate the type of call. For example, the recipient/caller may use a recipient/caller personal identification number unique only to an access number or temporary calling card number. Therefore, in situations where the phone number cannot be determined, the recipient/caller personal identification number entered by the recipient/caller can stipulate a call as either an access number call or a temporary calling card number call.

At step 712, the method 700 transfers the current telephone call to the calling card user's roaming number. For example, if the roaming number were set, the method 700 would connect (i.e., forward) the recipient/caller to the calling card user via the roaming number. At step 714, the recipient/caller's caller identification is transmitted to the calling card user. In one embodiment, if the recipient/caller does not have an operable caller identification system, the method 700 may prompt the recipient/caller to enter caller identification such as code numbers, phrases, voice prompts, and the like. Alternatively, the recipient/caller personal identification number may be associated with the number dialed by the calling card user, from the number called column 424, and transmitted to the recipient/caller.

At step 716, the method 700 determines whether to time the telephone call or not. In one embodiment, the method 700 determines if the telephone call should be timed by examining the telephone call type derived at step 710, stipulating that an access call number is a non-timed telephone call and a temporary calling card number is a timed telephone call. If the telephone call is not timed, then the method proceeds to step 718. At step 718, the method 700 determines if the telephone call has ended. If the telephone call has not ended, the method 700 loops back to step 718. If the telephone call has ended, the method 700 proceeds to step 728 and exits. If the telephone call is to be timed, the method proceeds from step 716 to step 722 to determine if the temporary calling card minutes from the temporary calling card minute column 416, associated with the recipient/caller personal identification number, have been exceeded. If the temporary calling card call back minutes have been exceeded, the method 700 proceeds to step 726 to send an error message to the recipient/caller and then exits at step 728. If the temporary calling card minutes have not been exceeded, the method 700 proceeds to step 724 and reduces the temporary calling card minutes by the duration of the telephone call. The method 700 proceeds to step 720 to determine if the telephone call has ended. If the telephone call has not ended, the method 700 returns to step 722. If the telephone call has ended, the method 700 proceeds to step 728 and exits. Accordingly, the recipient/caller may call the calling card user until either the temporary calling card minutes have expired and/or in another aspect, the expiration date has lapsed.

While the foregoing is directed to embodiments of the invention, other and further embodiments of the invention may be devised without departing from the basic scope thereof, and the scope thereof is determined by the claims that follow.

What is claimed is:

1. A method of processing call back information at a telecommunications processing system, comprising:
receiving, from a telecommunications device, call back configuration input from a user of the telecommunications device; and
storing call back information in a data repository according to the call back configuration input; wherein at least a part of the call back information is to be transmitted to at least one other telecommunications device during a telephone call to the at least one other telecommunications device from the user using a telephone calling card to make the telephone call.

2. The method of claim 1, wherein storing comprises associating the call back information with an identification number associated with the telephone calling card.

3. The method of claim 1, wherein the call back information is adapted to be used by a recipient to call the user of the telecommunications device.

4. The method of claim 1, wherein storing comprises associating the call back information with at least one of the telephone calling card and the user of the telephone calling card.

5. The method of claim 1, wherein the call back information is selected from at least one of a user name, a current number associated with the telecommunications device, a roaming number, a temporary calling card number, a message, an access number and combinations thereof.

6. The method of claim 1, wherein the call back information comprises a calling card user identity.

7. The method of claim 1, wherein the call back information comprises at least one call back number.

8. The method of claim 1, wherein the call back information comprises at least one message.

9. A method of processing a telephone call at a communication processing system, wherein the telephone call is made from a first telecommunications device to a second telecommunications device by a caller using a calling card, comprising:
processing a telephone calling card identification number received from the first telecommunications device;
retrieving call back information associated with the telephone calling card identification number; and
transmitting at least part of the call back information to the second telecommunications device.

10. The method of claim 9, wherein the calling card call back information comprises at least one of a user name, a current number associated with the first telecommunications device, a roaming number, a temporary calling card number, a message, an access number and combinations thereof.

11. The method of claim 9, further comprising determining whether the telephone call is a timed call.

12. The method of claim 11, wherein determining whether the telephone call is a timed call comprises comparing the calling card identification number to temporary calling card data.

13. The method of claim 12, wherein if the telephone call is a timed call then determining a duration of the telephone call and reducing an allocated amount of available time by the duration of the telephone call.

14. The method of claim 9, wherein the calling card call back information comprises a call back number.

15. The method of claim 14, wherein the call back number is selected from a temporary calling card number, an access number, a default number, a current number associated with the first telecommunications device used by a calling card user to configure the call back information, and combinations thereof.

16. The method of claim 9, wherein retrieving comprises determining whether the call back information should include a timed call back information.

17. The method of claim 16, wherein determining whether the call back information should include the timed call back information comprises determining if a roaming number is available.

18. The method of claim 17, wherein if the roaming number is available then determining if the call back information includes a temporary calling card information.

19. The method of claim 18, wherein if the call back information includes the temporary calling card information, then determining a temporary calling card identification number.

20. The method of claim 18, wherein if the call back information does not include the temporary calling card information then determining an access number.

21. The method of claim 20, wherein determining an access number comprises determining an access number identification number.

22. The method of claim 17, wherein if the roaming number is not available then determining at least one alternative number.

23. The method of claim 22, wherein determining the at least one alternative number comprises retrieving at least one caller identification data from the first telecommunications device.

24. The method of claim 23, wherein if the caller identification data from the telecommunications device is available then providing at least one current number.

25. The method of claim 23, wherein if the caller identification data from the telecommunications device is not available then providing a default number.

26. A telecommunications system for processing telephone calls made from telecommunications devices, comprising:
a data repository containing call back information associated with a calling card;
a processing system configured to at least:
receive a telephone call from a first telecommunications device to a second telecommunications device, wherein the telephone call is made from the first telecommunications device by a caller using the calling card;
retrieve the call back information associated with the calling card; and
transmit at least part of the call back information to the second telecommunications device.

27. The telecommunications system of claim 26, wherein the processing system is further configured to retrieve the call back information associated with the telephone calling card using an identification number received from the first telecommunications device.

28. The telecommunications system of claim 26, wherein the call back information comprises at least one of a user name, a current number associated with the first telecommunications device, a roaming number, a temporary calling card number, a message, an access number, and combinations thereof.

29. The telecommunications system of claim 26, wherein a telephone number used to make the telephone call is selected from at least one of a current number associated with the first telecommunications device, a roaming number, a temporary calling card number, an access number, default number, and combinations thereof.

30. The telecommunications system of claim 26, wherein the processing system determines a telephone call type.

31. The telecommunications system of claim 30, wherein if the telephone call type is a timed telephone call, then the processing system determines the time limit of the telephone call.

32. The telecommunications system of claim 31, wherein the processing system reduces an allocated time limit by a duration of the telephone call.

33. The telecommunications system of claim 26, wherein the processing system determines the type of call back information to transmit to the second telecommunications device.

34. The telecommunications system of claim 33, wherein the processing system retrieves at least some of the identification of the first communication device.
